(19) United States
(12) Patent Application Publication
(10) Pub. No.: US 2012/0107758 A1
(43) Pub. Date: May 3, 2012

(54) DIRECT SPRAY COOLING FOR LIMESTONE PREHEATERS

(75) Inventors: Charles R. Euston, Hamburg, PA (US); Ronald K. Riddle, Lehighton, PA (US); Gene Basara, II, Bethlehem, PA (US)

(73) Assignee: FLSmidth A/S, Valby (DK)

(21) Appl. No.: 12/917,512

(22) Filed: Nov. 2, 2010

(51) Int. Cl. F27B 1/24; F27D 13/00

(52) U.S. Cl. 432/14; 432/100

(57) ABSTRACT

A preheating apparatus for particulate material using hot kiln gases to preheat the particular material. The apparatus has a means to cool the hot kiln gases prior to the gases being exhausted from the preheating apparatus.

### BACKGROUND OF THE INVENTION

This invention in general relates to a method and apparatus for preheating particulate material.

Although the present invention is applicable generally to the preheating of particulate material, it is particularly applicable to apparatus and processes for the preheating and precalcining of limestone by flowing the limestone and the hot kiln gases from the calcining kiln in countercurrent heat exchange relationship to each other. The preheating apparatus of this general type are known.

In such prior art preheaters the kiln off gases, after passing through and preheating the particulate material, are directed from the preheater to a dedusting device, such as a baghouse. However, exit gases, if untreated prior to the dedusting stage, will typically exceed the temperature limitations of a fabric baghouse requiring, as a crucial additional step, the cooling of the preheater exit gases prior to dedusting.

Prior art methods of cooling such exit gases have not been entirely satisfactory. One common treatment is to insert ambient “bleed air” into the system in the vicinity of the preheater gas exit ducts or intermediate the preheater gas exit ducts and the baghouse. This method will result in a potentially significant increase in the gas volume that must be handled by the preheater's induced draft fan, which will limit preheater capacity and increase the energy required by the induced draft fan.

In another, not as conventional, method, it has been proposed to use conventional evaporative cooling towers (ECT) to cool hot preheater exit gases. ECTs are a separate process vessel located outside a preheater and before the dust cleaning device and use a separate cooling tower to spray water into the gas stream. ECT's are typically designed to evaporate all of the cooling water. Some of the disadvantages inherent with this solution include a prohibitively high initial capital cost; wetting of the baghouse fabric bags due to improper nozzle atomization and “wet bottoms”, which is a term used to denote buildups and plugging caused by the liquid water combining with the dust in the exit gases at times of malfunction.

It is an object of this invention, therefore, to have a method of cooling preheater exhaust gases that does not have the disadvantages of the methods described above.

### DESCRIPTION OF THE INVENTION

According to the present invention the above and other objects are achieved by providing individual water spray nozzles in at least one preheater exhaust chimney (i.e. the preheater exhaust ducts) to spray cooling water into the exhaust gas stream as it is leaving the preheater. The water spray will cool the gas which will as a result be condensed to a decreased volume. This will decrease the energy and size requirements of the induced draft fan and increase preheater capacity.

It is another feature of the invention that the direction of the water spray will be downward through the gas stream and in the direction of the particulate material bed that is being preheated. Thus, water that may not be evaporated, for any reason, by its contact with the heated exhaust gases will fall upon and be dissipated by the packed material bed. This results in a significantly decreased possibility that exhaust ducts will become plugged or that the cooling water will wet the baghouse fabric bags.

### DESCRIPTION OF THE DRAWINGS

The invention will now be described in further details by way of an example of a preheater according to the invention and with reference to the following drawings in which like numerals are employed to designate like parts and in which:

FIG. 1 is schematic in cut away depicting a preheater and kiln utilized in the present invention, with a prior art off gas cooling system.

FIG. 2 is similar to FIG. 1, with the prior art off gas cooling system being replaced by the cooling system of the present system.

FIG. 3 depicts a water spray nozzle being inserted in a preheater gas “chimney”.

The Figures are not necessarily drawn to scale.

### DETAILED DESCRIPTION OF THE INVENTION

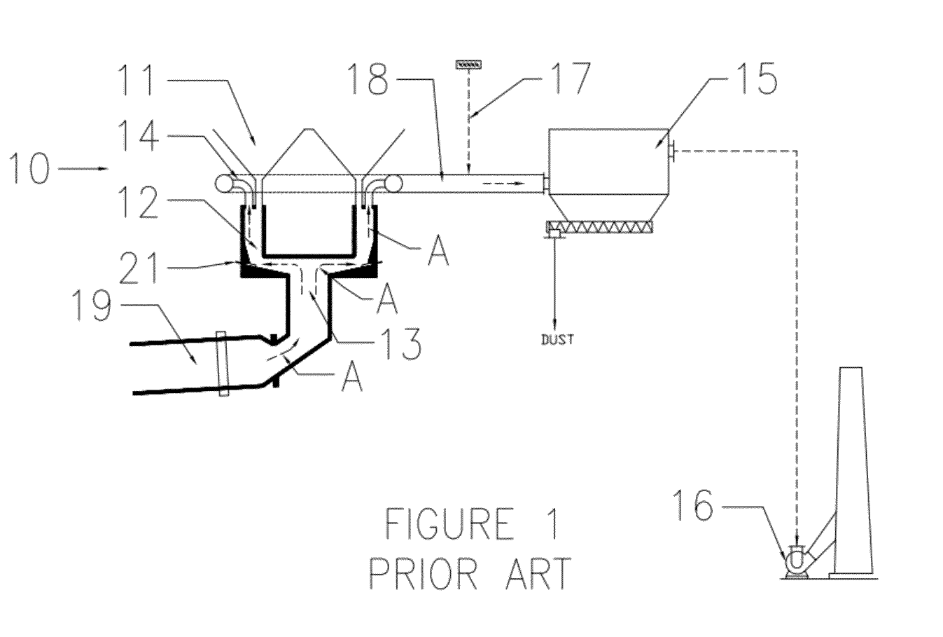

With reference to FIG. 1, there is an apparatus 10 for preheating and precalcining limestone, the limestone is supplied to an overhead storage bin 11 and directed downwardly through a vertically situated annular preheating and precalcining passage 12 that ends in a sloped floor leading to central discharge 13. The movement of limestone to the central discharge located at the bottom of annular preheating and precalcining passage 12 is facilitated by a reciprocating material pusher 21. Preheating hot gases (represented by arrows A) from kiln 19 flow in countercurrent heat exchange relation through at least the lower region of the annular preheating and precalcining passage 12. The hot kiln gases are exhausted from the preheating apparatus, and consequently are separated from the downwardly moving packed limestone bed, in one or more exhaust chimneys 14 located adjacent to and above the upper area of the annular preheating and precalcining passage 12 and more or less equally spaced around the perimeter of the preheater. In a typical preheater there may be from 8 to 24 chimneys 14. These chimneys direct the exhaust gases into a common gas exit exhaust line 18. Hot (appx. 950° C. to 1200° C.) kiln gases are then directed via exhaust line 18 out of preheating apparatus 10 to baghouse 15 in which they are dedusted. Process gases are drawn through the system by ID fan 16. In order to cool the off gases to a temperature (appx. 245° C. to 255° C.) that can be tolerated by baghouse 15, a prior art system as depicted introduces ambient air (appx. 20° C.) via duct 17 into exhaust line 18 prior to baghouse 15 to reduce the kiln gases to the desired temperatures.

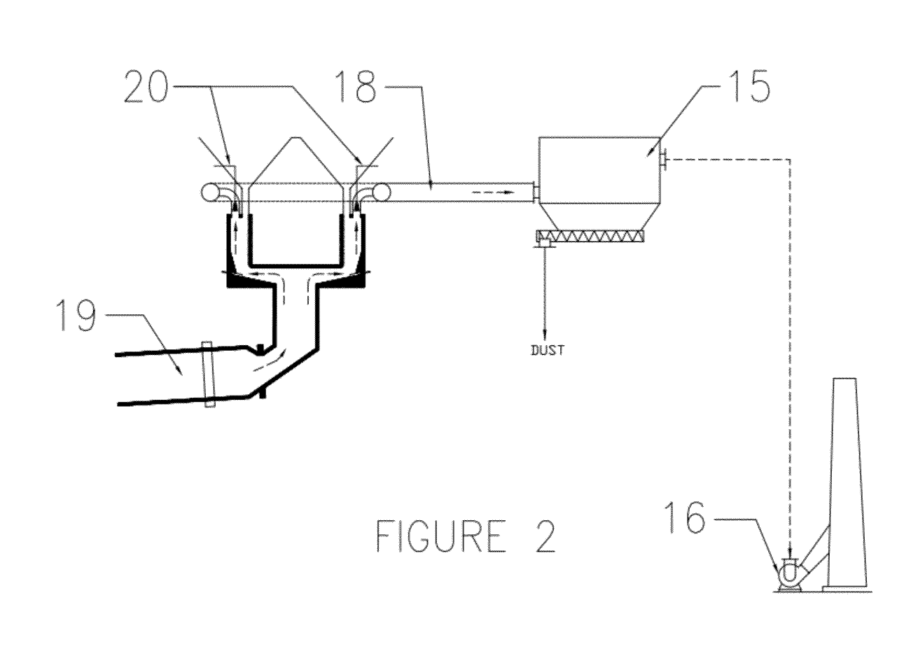

The system of FIG. 2 is identical to that of FIG. 1, with the exception that there is no introduction of cooling ambient air into the system, and duct 17 has been replaced by one or more water spray means 20, which directs water into the kiln gases and in the direction of the moving stone bed to thereby reduce the kiln gases to the desired temperatures. According to the present invention cooling water is sprayed into kiln gas after the kiln gas passes through the stone bed and prior to it exiting the preheater. The water spray is directed into the kiln gas and in the direction of the moving stone bed that is moving downward through the annular flow passage so that any water that is not evaporated in the kiln gas will impact the stone bed. The placement of the water spray means 20 will depend on the specific design of the preheater on which it is employed.

The systems specified in FIG. 1 and FIG. 2 will both reduce the temperatures of the preheater exhaust gases to levels that can be successfully tolerated by the baghouse. However, replacing the system of FIG. 1 with that of the present invention (FIG. 2) will result in a significant reduction (approximate 30%, based on actual gas volume) of the process air that must be moved by the system's induced draft fan 16, which results in both an increase in capacity and reduced energy requirements.

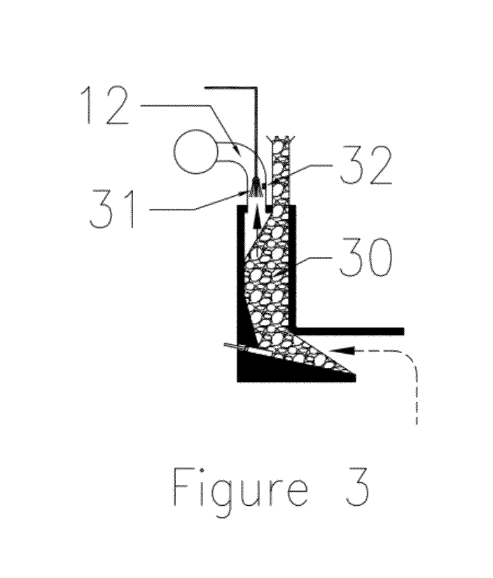

FIG. 3 shows one embodiment of the present invention. An individual exhaust chimney 12 is depicted through which kiln off gases pass after said gases have exited limestone bed 30. Exhaust chimney 12 will direct the gas out of preheater 10 and into common exhaust duct 18. Spray nozzle 31 is inserted into chimney 12 and directs atomized water spray downward into the chimney in the direction of the packed bed 30, with the water cooling the exit gas. Preferably the nozzle is positioned from 3 to 10 feet above packed bed 30. The water will thereby pass into the exhaust gas after the exhaust gas has passed through packed bed 30 but prior to it exiting preheater 10. Furthermore, by positioning each spray nozzle directly over the moving stone bed 30 and thereby directing the water spray toward moving stone bed 30, “wet bottom” problems are avoided if the nozzle atomization fails, as any water passing through the exhaust gas will impact upon the packed bed, where it is evaporated.

In an alternative embodiment, temperature monitor 32 can be inserted within each chimney giving the practitioner of the invention the option of selectively cooling chimneys based on their temperature, i.e. only chimneys that reach a preselected temperature can be cooled if desired.

By utilizing individual spray nozzles for each chimney, each chimney can be monitored separately and additional spray nozzles can be added or removed as needed. The practitioner of the invention can maintain overall control on the system by controlling the total water being utilized.

The present invention can be easily retrofitted to existing plants and can reduce the temperature of preheater exit gases without necessitating a large increase in exit gas volume.

We claim:

1. A preheating apparatus for particulate material comprising:
a flow passage for the particulate material having an upper region and a lower region, said lower region having a material discharge,
means for introducing hot kiln gases into the lower region of said flow passage for passing the gases upward through the particulate materials in countercurrent heat exchange relationship with the particulate material,
means to exhaust the hot kiln gases from the preheating apparatus after said hot kiln gases have passed through and preheated the particulate material; and
means to inject cooling water into the hot kiln gases after the gases have passed through the particulate material but before they have been exhausted from the preheating apparatus.

2. The preheating apparatus of claim 1 wherein the particulate material is limestone.

3. The preheating apparatus of claim 1 wherein the cooling water is directed toward the particulate material in the flow passage.

4. The preheating apparatus of claim 3 wherein means to exhaust the hot kiln gases from the preheating apparatus are one or more exhaust chimneys situated in the upper region of the flow passage.

5. The preheating apparatus of claim 4 wherein the means to inject cooling water is a water spray atomizer that is inserted into the one or more exhaust chimneys.

6. A method of preheating particulate material in a preheating apparatus comprising:
passing preheating gases in the preheating apparatus upward through the particulate material in countercurrent heat exchange relationship with the particulate material,
exhausting the preheating gases from the preheating apparatus after having passed through the particulate material, and
directing cooling water into the preheating gases after said gases have passed through the particulate material but before they have been exhausted from the preheating apparatus to thereby cool the preheating gases and condense their volume.
